(19) United States
(12) Patent Application Publication
(10) Pub. No.: US 2013/0073621 A1
(43) Pub. Date: Mar. 21, 2013

(54) ENFORCING COMMUNICATION POLICY RULES ON SHARED DOCUMENTS

(71) Applicants: Nathan Waddoups, Redmond, WA (US); Kartik Murthy, Seattle, WA (US)

(72) Inventors: Nathan Waddoups, Redmond, WA (US); Kartik Murthy, Seattle, WA (US)

(73) Assignee: Microsoft Corporation, Redmond, WA (US)

(21) Appl. No.: 13/238,061

(22) Filed: Sep. 21, 2011

(51) Int. Cl. G06F 15/16

(52) U.S. Cl. 709/204

(57) ABSTRACT

A system is provided for automatically enforcing communication policy rules for document sharing between a communication server and a publishing server. The system may enable a policy agent to examine a communication containing a document attachment before the communication may be delivered to a recipient. The policy agent may evaluate the communication against communication policy rules, and if the policy agent determines that the communication policy rules are not violated, then a document upload agent may transfer the attached document to the publishing server. The system may then deliver the communication message to the recipient. If the policy agent determines that the communication policy rules are violated, then the system may prevent the document upload agent from transferring the attached document to the publishing server and may continue to deliver the communication to the recipient without the document attachment.

### BACKGROUND

In a collaborative authoring environment, multiple users may exchange documents using document exchange methods in order to share the document and to collaborate on a document. Some document exchange methods may include e-mail messaging, text messaging, conferencing, whiteboard sharing, desktop sharing, and application sharing. In a collaborative authoring environment, a publishing server may also be utilized for providing multiple users in the collaborative authoring environment to have access to a document for sharing the document and collaborating on the document. Typically to share a document in the collaborative environment, the document may be manually uploaded to the publishing server by a user, and additionally the user may include the document as an attachment to an email which the recipient may then upload to the publishing server. This can result in conflicting versions of the document existing within the collaborative environment.

Often times in a collaborative environment, an organization may enable access and permission settings for establishing who may have access to documents and files within the collaborative environment. Additionally, an organization may define communication policy rules for establishing which users and groups in the collaborative environment may be permitted to communicate with one another. The organization may utilize the communication rules to prevent communication between specific groups and users. It may be difficult to monitor prohibited communications and document exchange between groups and users when a document is shared over the publishing server providing access to the document by multiple users within the collaborative environment.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a system for automatically enforcing communication policy rules for document sharing between a communication server and a publishing server. The system may enable coordination of document sharing between a communication server and a publishing server in a cloud based or enterprise network environment, such that when a communication containing an attached document is sent through the communication server, the system may automatically remove the attached document and directly upload the attached document to the publishing server. The system may enable a policy agent residing on the communication server to examine the communication containing a document attachment for communication policy rule violations before the communication may be delivered to a recipient. The policy agent may evaluate the communication against the communication policy rules, and if the policy agent determines that the communication policy rules are not violated, then a document upload agent may automatically transfer the attached document to the publishing server. Embodiments may be implemented in collaborative authoring or non-collaborative document distribution settings.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a system utilizing communication policy rules in a collaborative environment, according to embodiments;

FIG. 2 illustrates a system for enforcing communication policy rules for document sharing between a communication server and a publishing server, according to embodiments;

FIG. 3 illustrates an example system for evaluating communication policy rules in a collaborative environment, according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process for enforcing communication policy rules for document sharing between a communication server and a publishing server, according to embodiments.

### DETAILED DESCRIPTION

As briefly described above, a system is provided for automatically enforcing communication policy rules for document sharing between a communication server and a publishing server. The system may enable coordination of document sharing between a communication server and a publishing server in a cloud based environment, such that when a communication containing an attached document is sent through the communication server, the system may automatically remove the attached document and directly upload the attached document to the publishing server. The system may enable a policy agent to examine a communication containing a document attachment before the communication may be delivered to a recipient to determine if the communication violates defined communication policy rules. In some embodiments, a document attachment in the communication may be replaced with a link to the document in the publishing server, and the communication server may then deliver the communication message to the recipient. If the policy agent determines that the communication policy rules are violated, then the system may prevent the document upload agent from transferring the attached document to the publishing server. The communication server may continue to send the communication to the recipient without the document attachment or the communication server may prevent the communication from being delivered.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for collaborative document authoring and exchange. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below. Moreover, embodiments may be implemented in collaborative authoring or non-collaborative document distribution settings, as well as in cloud-based or enterprise environments.

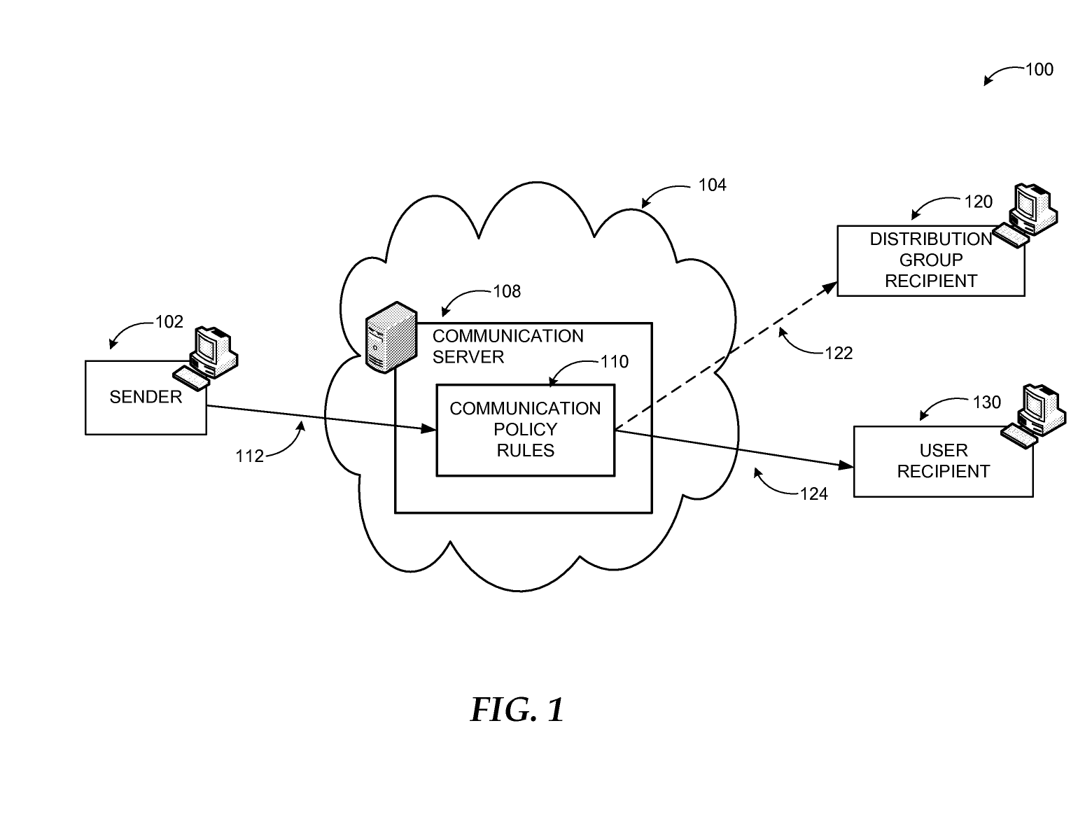

FIG. 1 illustrates, in diagram 100, a system utilizing communication policy rules in a collaborative environment according to embodiments. In a collaborative environment, an organization may utilize communication policy rules 110 to prevent communication between specific groups and users. As an example scenario, in a bank setting, stock traders may be legally forbidden from conversing with stock analysts. The bank may set up communication policy rules on the bank's communication server to prevent e-mail from being exchanged between the group of stock traders and the group of stock analysts.

In an example embodiment, a communication policy rule for an organization in a cloud based environment 104 may specify that e-mail communication is prohibited between a particular sender 102 and a distribution group 120. When the sender 102 attempts to send 112 an e-mail message over a communication server 108 to the distribution group 120, the communication server 108 may examine the e-mail message to determine if the communication is permitted or prohibited by the communication policy rules 110. If the system determines that communication policy rules 110 prohibit the communication between the sender 102 and the distribution group 120, then the communication server 108 may prevent 122 the e-mail message from being delivered to the distribution group 120 and may inform the sender that the e-mail message was not delivered, via a non-delivery report for example. If the system determines that communication policy rules 110 allow the communication between the sender 102 and a designated recipient 130, then the communication server 108 may deliver 124 the e-mail message to the designated recipient 130.

In a further example, communication policy rules 110 may exist preventing the sharing of documents and files between users and groups over the communication server 108 in the cloud based environment 104. In the cloud based environment 104, the communication server 108 may enable documents to be shared and exchanged using a variety of document sharing methods, such as for example, e-mail messaging, text messaging, conferencing, whiteboard sharing, desktop sharing, and application sharing. The communication server 108 may implement communication policy rules 110 to prevent the sharing of the documents using the available document sharing methods.

For example, upon the initiation of document sharing over the communication server 108, such as a desktop share or an e-mail message containing an attached document, the communication server 108 may apply the communication policy rules 110 and determine that the sharing of the particular document is prohibited. The communication server 108 may subsequently block the document from being shared between the users and may block delivery of the desktop share request or delivery of the e-mail message. Additionally, the system may be configured to apply communication policy rules 110 to monitor document sharing communications for keywords that may include confidential, illegal and/or offensive content, and the communication server 108 may prevent communications from being sent and documents from being exchanged if the communication policy rules 110 are determined to be violated by the communication containing the keywords.

Embodiments may also be implemented in collaborative authoring or non-collaborative document distribution settings, where after a document is finalized (collaboratively or otherwise) someone may send it to an audience of one or more recipients for them to read, but with no expectation of feedback or other contributions to the document. Furthermore, embodiments may also be implemented in enterprise environments, where all of the components/servers are owned by the organization that is using them, and are located on the organization's premises, as opposed to cloud-based systems.

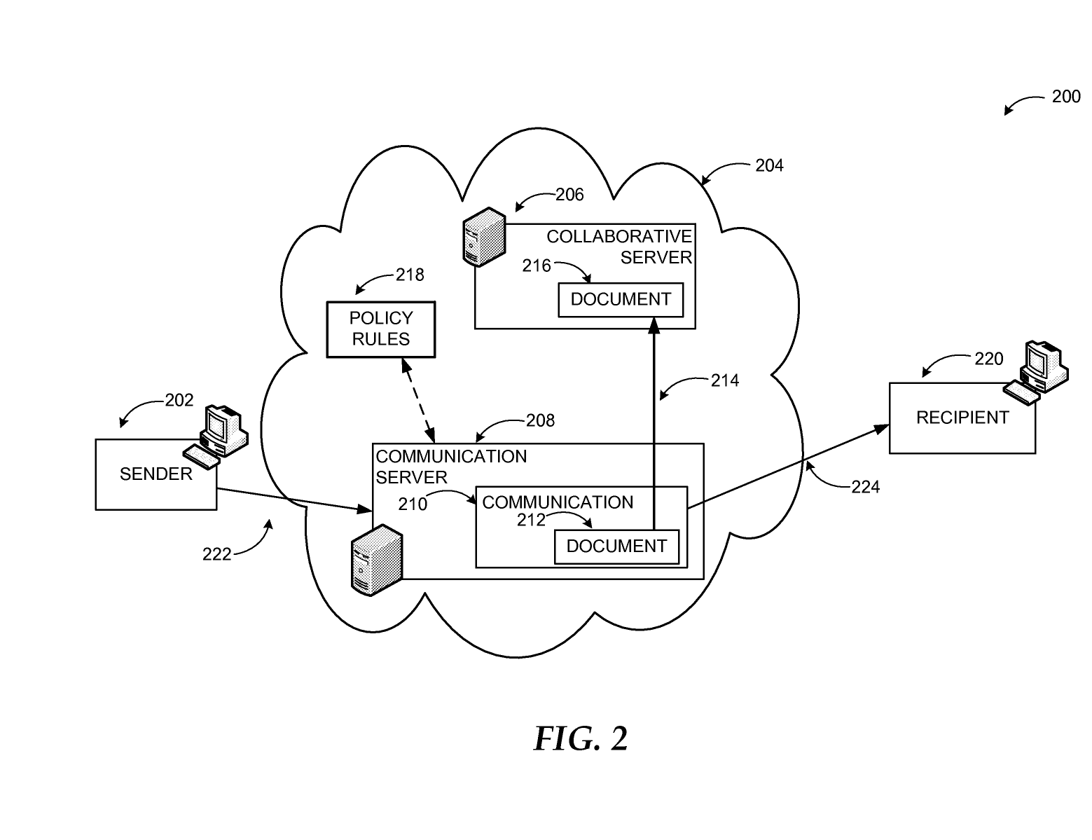

FIG. 2 illustrates a system for enforcing communication policy rules for document sharing between a communication server and a publishing server, according to embodiments. A system according to embodiments, as shown in diagram 200, may be configured to enable coordination of document sharing between a communication server 208 and a publishing server 206 in a cloud based environment 204, such that when a communication 210 containing an attached document 212 is sent through the communication server 208, the system may automatically remove the attached document 212 and directly upload 214 the attached document to the publishing server 206. In some embodiments, publishing server 206 may be a collaborative server. The incoming communication 210 containing the attached document 212 may be any type of communication enabling document sharing including an e-mail message, a text message, a conference request, whiteboard share request, and desktop share request.

In an example embodiment, when the communication 210 is received through the communication server 208, the communication server 208 may be configured to automatically remove the attached document 212 from the communication 210, and may directly upload 214 the attached document 212 to the publishing server 206 for storage in a central document repository provided by the publishing server 206, enabling the document 216 to be accessed by any of the users within the cloud based environment 204. The body of the communication 210 may be stored separately by the communication server 208, and the attached document 212 may be replaced in the body of the communication 210 by a link to the document 216 where it is stored in the publishing server 206. The communication server 208 may subsequently deliver 224 the modified communication with the link to the document 216 in the publishing server 206 to the recipient 220. The coordinated system thus may enable a one step process for sending a document to a recipient and automatically uploading the document to the publishing server 206.

A system according to embodiments may be configured to integrate communication policy rules 218 with the document sharing coordination between the communication server 208 and the publishing server 206. As discussed above in conjunction with FIG. 1, an organization in the cloud based environment 204 may utilize communication policy rules 218 to prevent communication between specified groups and users and to control access to documents shared over the communication server 208. The communication server 208 may be any type of communication service enabling document exchange and sharing, such as e-mail messaging, text messaging, conferencing, whiteboard sharing, desktop sharing, and application sharing, for some examples. Documents that may be shared and exchanged may include word processing application files, spreadsheet application files, presentation application files, audiovisual files, calendar items and other data-containing files. The communication policy rules 218 may specify that communication between specified users and groups is prohibited. Additionally, the communication policy rules 218 may specify that sharing and exchanging of documents between specified users and groups is also prohibited.

In an example embodiment, the system may be configured to enable the communication server 208 to apply the communication policy rules 218 when the communication 210 containing the attached document 212 is received 222 through the communication server 208. Upon receipt 222 of the communication 210 containing the attached document 212, the system may apply the communication policy rules 218 to ensure that it is permitted for the sender 202 and the recipient 220 to be communicating and/or sharing documents. If the system determines that the communication 210 is in violation of one or more of the communication policy rules 218, then the system may prevent the attached document 212 from being automatically uploaded 214 to the publishing server 206. If, however, the system determines that the communication 210 is not in violation of one or more of the communication policy rules 218, then the system may allow the attached document 212 to be automatically uploaded 214 to the publishing server 206 for storage. The communication server 208 may then replace the attached document 212 with the link to the document 216 in the publishing server 206 and the body of the communication 210 may be delivered 224 to the recipient 220.

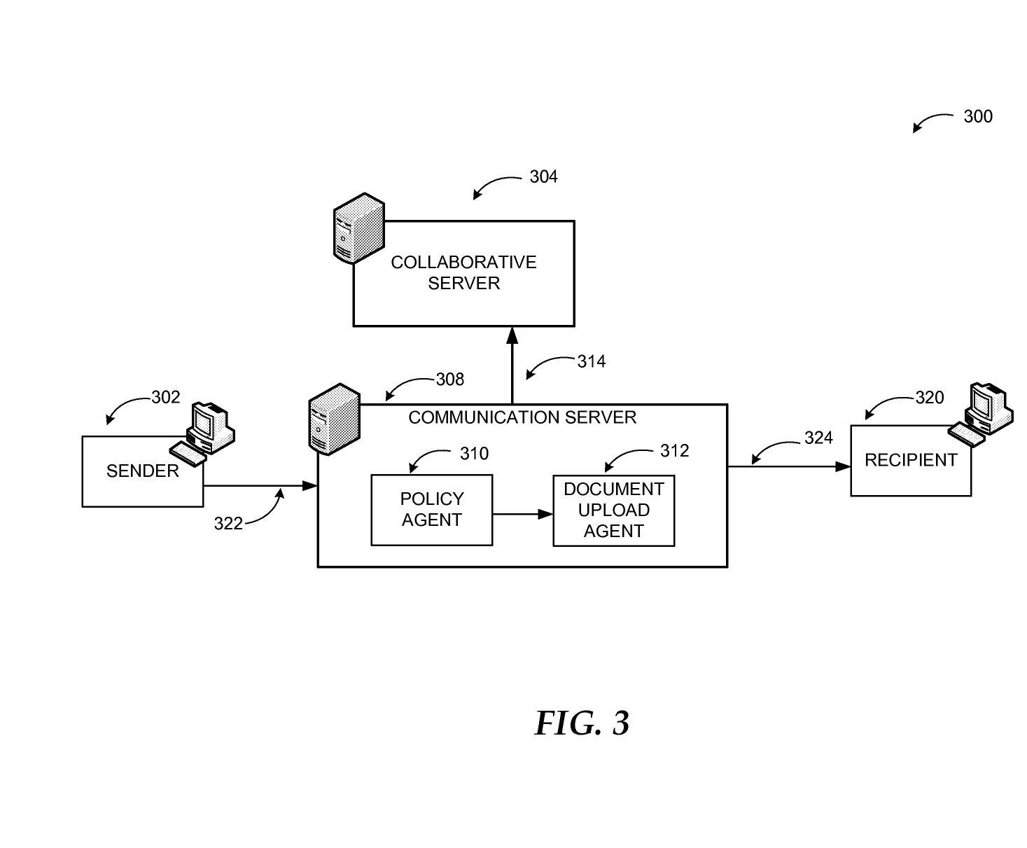

FIG. 3 illustrates an example system for evaluating communication policy rules in a collaborative environment, according to embodiments. A system according to embodiments, as shown in diagram 300, may employ a policy agent 310 and a document upload agent 312 for examining communications and automatically uploading attached documents to the publishing server 304. The policy agent 310 and the upload agent 312 may reside on the communication server 308 for examining incoming communications enabled for document sharing through the communication server 308.

In an example embodiment, the communication server 308 may be configured to apply the policy agent 310 initially upon receipt 322 of an incoming communication containing an attached document. The policy agent 310 may be applied first to evaluate the communication to determine if it violates any of the communication policy rules, in order to ensure that the attached document is not uploaded to the publishing server 304 providing access to the document by one or more of the prohibited recipients. If the policy agent 310 determines that there is no violation of the communication policy rules, the policy agent 310 may release the communication to the upload agent 312, which may automatically upload the attached document to the publishing server 304, replace the attached document in the body of the communication with a link to the document in the publishing server, and deliver 324 the communication to the recipient 320. If the policy agent 310 determines that the communication and the attached documents violate one or more of the communication policy rules, the policy agent 310 may prevent the attached document from being automatically uploaded 314 to the publishing server 304 by the upload agent 312. Additionally, the policy agent 310 may prevent the communication from being delivered 324 to the recipient 320. In another embodiment, the policy agent 310 may prevent the upload agent 312 from uploading the document to the publishing server 304 and may remove the attached document from the communication before delivering 324 the communication to the recipient 320. The policy agent 310 may also be configured to modify the communication to indicate that the communication violates the communication policy rules, and the communication server 308 may continue to deliver 324 the modified communication to the recipient 320 without the attached document.

In an alternative embodiment, the communication server 308 may apply the upload agent 312 first upon receipt 322 of the incoming communication from the sender 302, and may then apply the policy agent 310 to evaluate the communication to determine if one or more communication policy rules are violated. In such a scenario, the document may be uploaded to the publishing server 304 before the communication is examined by the policy agent 310 for communication policy rule violations. If after the document is uploaded, the policy agent 310 subsequently determines that one or more communication policy rules are violated, then the policy agent 310 may prevent the communication from being delivered 324, so that the recipient 320 is not made aware of the uploaded document in the publishing server 304. Additionally, the policy agent 310 may be configured to flag the uploaded document in the publishing server 304 in order to enable the publishing server to set permission and access settings preventing unauthorized users from accessing the uploaded document on the publishing server 304. The policy agent 310 may also be configured to indicate to the upload agent 312 that the document should not have been uploaded, and the upload agent 310 may be configured to remove the document from the publishing server 304.

In a further embodiment, the policy agent 310 and the upload agent 312 may reside on the publishing server 304, such that when the communication is delivered to the recipient 320 through the communication server 308, the publishing server 304 may coordinate with the communication server 308 to apply the policy agent 310 to determine if the communication violates the communication policy rules. If the communication policy rules are determined to be violated, then the upload agent 312 residing on the publishing server 304 may prevent the document from automatically uploading to the publishing server 304.

In yet another embodiment, the policy agent 310 and the upload agent 312 may be implemented as an independent module for enforcing the communication policy rules. The independent module may coordinate with the communication server 308 and the publishing server 304, and may monitor both concurrently in order to examine communications to determine if they violate the communication policy rules. The independent module may be configured to enable the policy agent 310 to examine communications containing attached documents when they are received 322 by the communication server 308, and if the communication violates communication policy rules, then the policy agent 310 in the independent module may prevent the communication from being delivered 324 or may modify the communication. The upload agent 312 may subsequently be prevented from automatically uploading the attached document in the communication to the publishing server.

The example systems in FIG. 1 through 3 have been described with specific configurations, applications, and interactions. Embodiments are not limited to systems according to these examples. A system for enforcing communication policy rules for document sharing between a communication server and a publishing server in a collaborative environment may be implemented in configurations employing fewer or additional components and performing other tasks. Furthermore, specific protocols and/or interfaces may be implemented in a similar manner using the principles described herein.

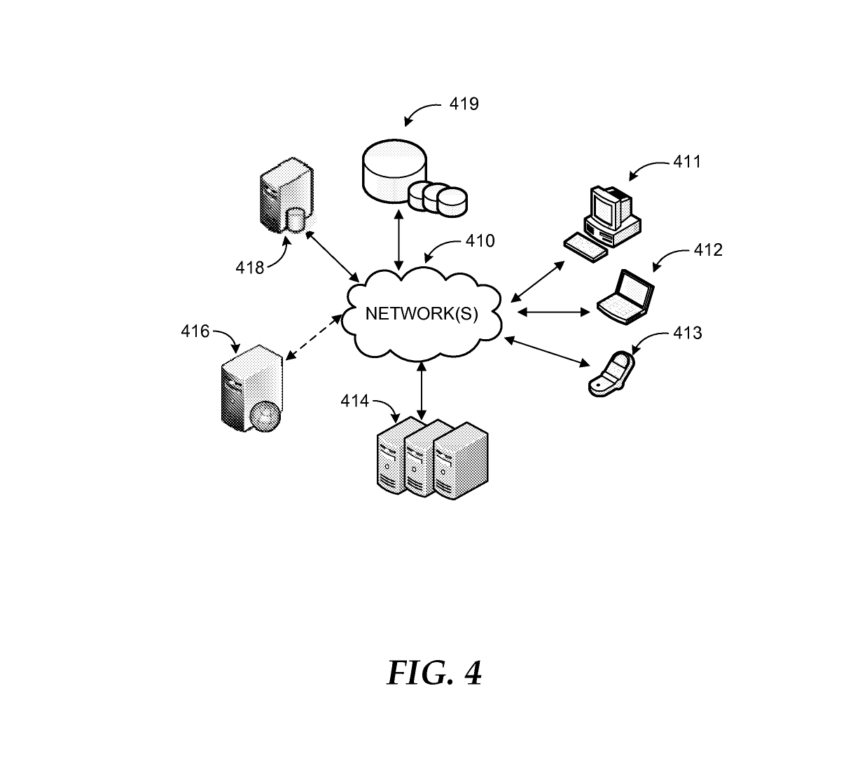

FIG. 4 is an example networked environment, where embodiments may be implemented. A system for enforcing communication policy rules for document sharing between a communication server and a publishing server in a collaborative environment may be implemented via software executed over one or more servers 414 such as a hosted service. The platform may communicate with client applications on individual computing devices such as a smart phone 413, a laptop computer 412, or desktop computer 411 (‘client devices’) through network(s) 410.

Client applications executed on any of the client devices 411-413 may facilitate communications via application(s) executed by servers 414, or on individual server 416. An application executed on one of the servers may facilitate automatically enforcing communication policy rules for document sharing between a communication server and a publishing server. The application may enable coordination of document sharing between a communication server and a publishing server in a cloud based environment, such that when a communication containing an attached document is sent through the communication server, the system may automatically remove the attached document and directly upload the attached document to the publishing server. The application may also integrate enforcing communication policy rules with the document sharing coordination between the publishing server and the communication server. The application may enable a policy agent to examine a communication containing a document attachment for communication policy rule violations and an upload agent to automatically upload the document attachment to the publishing server if no communication policy rules are violated before the communication may be delivered to a recipient. If the policy agent determines that the communication policy rules are violated, then the system may prevent the document upload agent from transferring the attached document to the publishing server, and may prevent the communication from being delivered to the recipient. The application may retrieve relevant data from data store(s) 419 directly or through database server 418, and provide requested services (e.g. document editing) to the user(s) through client devices 411-413.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a platform for enforcing communication policy rules for document sharing between a communication server and a publishing server in a collaborative environment. Furthermore, the networked environments discussed in FIG. 4 are for illustration purposes only. Embodiments are not limited to the example applications, modules, or processes.

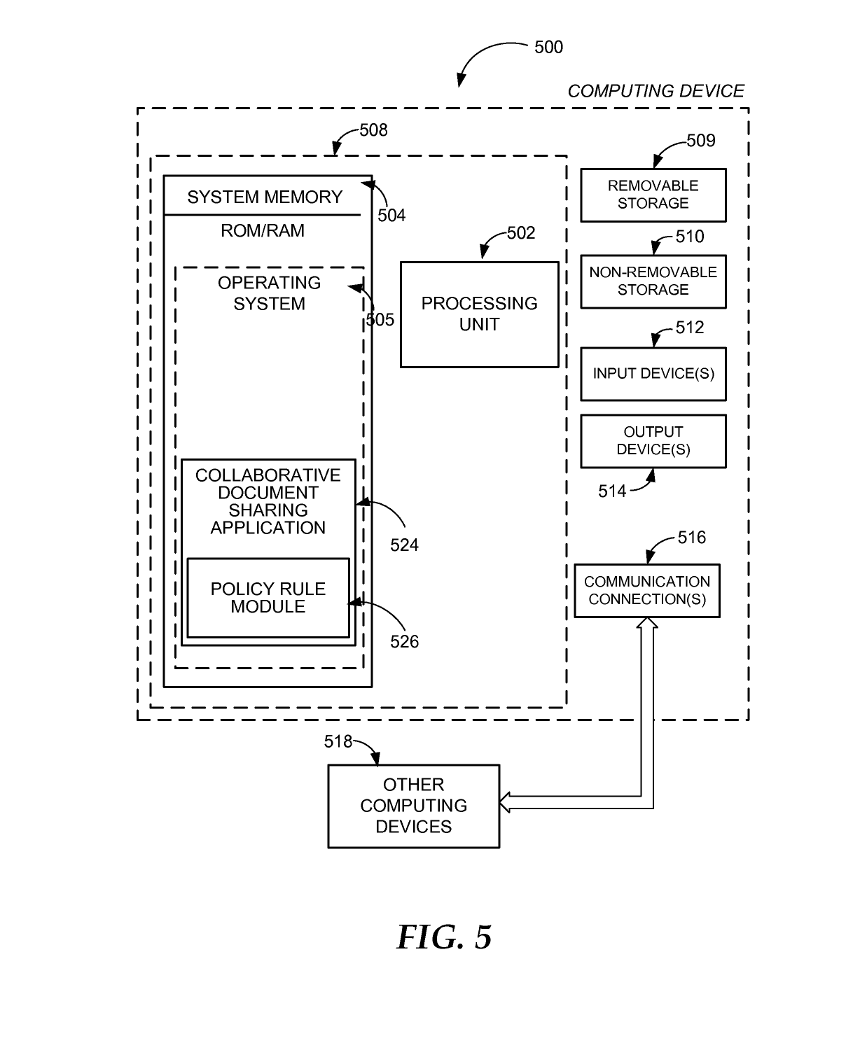

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing an application for enforcing communication policy rules for document sharing between a communication server and a publishing server in a collaborative environment according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as a collaborative document sharing application 524 and a policy rule module 526.

The collaborative document sharing application 522 may facilitate automatically enforcing communication policy rules for document sharing between a communication server and a publishing server. The application may enable coordination of document sharing between a communication server and a publishing server in a cloud based environment, such that when a communication containing an attached document is sent through the communication server, the system may automatically remove the attached document and directly upload the attached document to the publishing server. The collaborative document sharing application 524 may enable integrating enforcing communication policy rules with the document sharing coordination between the publishing server and the communication server. Policy rule module 526, which may be a distinct application or an integrated module of collaborative document sharing application 524, may enable a policy agent and a document upload agent residing on the communication server to examine the communications and automatically upload attached documents to the publishing server. The policy rule module 526 may automatically apply the policy agent upon receipt of the incoming communication containing the attached document to evaluate the communication to determine if it violates any of the communication policy rules, and if policy rules are determined not to be violated, the upload agent may automatically upload the document to the publishing server. Further, if the policy agent determines that the communication and the attached documents violate one or more of the communication policy rules, then the policy rule module 526 may be configured to enable the policy agent to prevent the communication from being delivered to the recipient. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

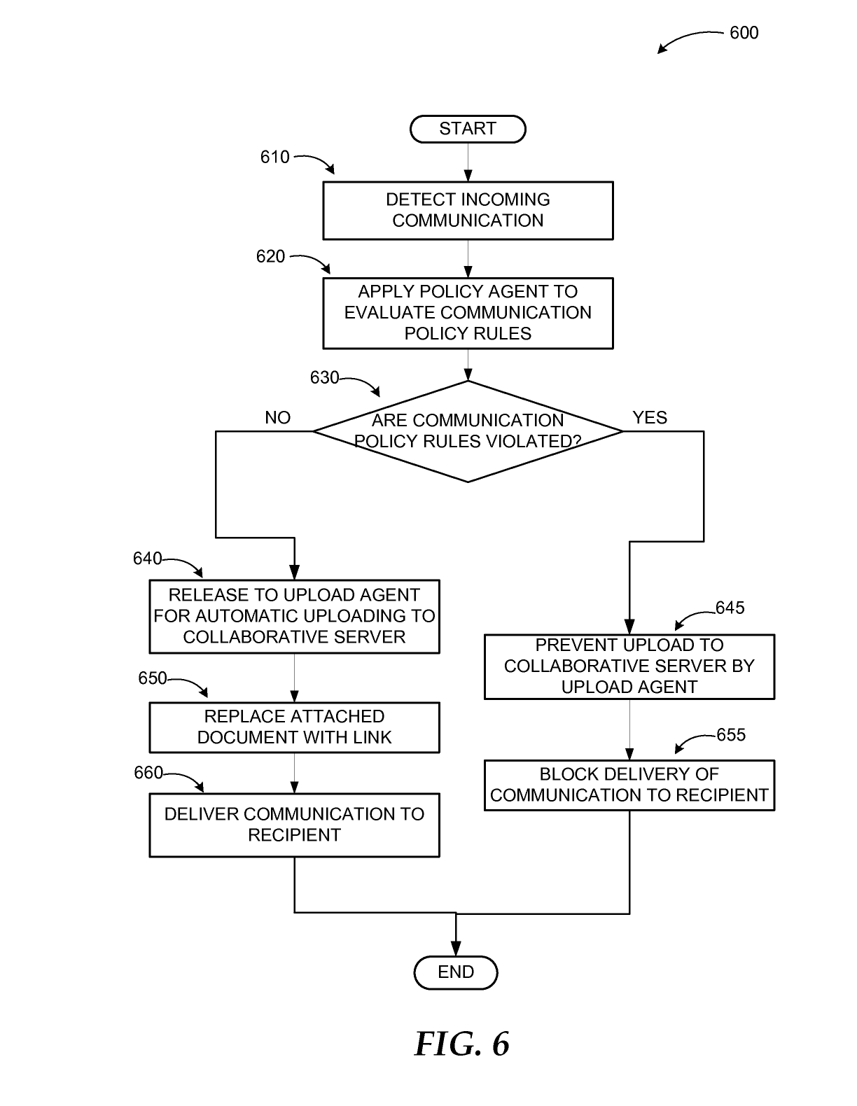

FIG. 6 illustrates a logic flow diagram for process 600 enforcing communication policy rules for document sharing between a communication server and a publishing server in a collaborative environment according to embodiments. Process 600 may be implemented on a computing device or similar electronic device capable of executing instructions through a processor.

Process 600 begins with operation 610, where the system may detect an incoming communication containing a document attachment from a sender through a communication server in a cloud based environment. The communication may be any type of communication enabling document sharing and exchange between two or more users or groups. At operation 620, a policy agent may be applied to evaluate the communication to determine if it violates any communication policy rules defined in the cloud based environment. The policy agent may reside on the communication server, and may be applied initially upon receipt of the communication by the communication server. At operation 630 policy agent may determine if the communication violates one or more of the communication policy rules defined in the cloud based environment.

If the policy agent determines that the incoming communication does not violate one or more of the communication policy rules, then at operation 640, the policy agent may release the communication containing the attached document to an upload agent for automatic uploading of the attached document to the publishing server. The upload agent may remove the document attachment from the body of the communication, and may automatically transfer the document to the publishing server where the document may be centrally stored enabling multiple users in the cloud based environment to access the document. At operation 650 the upload agent may replace the attached document in the body of the communication with a link to the document in the publishing server. Operation 650 may be followed by operation 660, where the communication server may subsequently deliver the communication without the attached document and containing the link to the document in the publishing server to the designated recipient.

If, however, at operation 640, the policy agent determines that the communication and the attached documents violate one or more of the communication policy rules, then at operation 645, the policy agent may not release to the upload agent, and may prevent the upload agent from automatically uploading the attached document to the publishing server. Operation 645 may be followed by operation 655, where the policy agent may subsequently prevent the communication server from delivering the communication to the designated recipient. Alternatively, the policy agent may modify the communication to indicate that the original communication violated one or more of the communication policy rules, and the communication server may deliver the modified message to the designated recipient without the attached document.

The operations included in process 600 are for illustration purposes. Enforcing communication policy rules for document sharing between a communication server and a publishing server in a collaborative environment may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for enforcing communication policy rules for document sharing in a collaborative environment, the method comprising:
detecting a communication associated with a document from a sender to a designated recipient through a communication server in the collaborative environment;
determining a communication policy rule associated with the communication; and
applying the communication policy rule to at least one from a set of: a storage, an access, and a distribution of the document within the collaborative environment.

2. The method of claim 1, further comprising:
if the communication does not violate the communication policy rule, then enabling automatic uploading of the document to a publishing server;
delivering the communication to the designated recipient; and
enabling the designated recipient to access the document through the publishing server.

3. The method of claim 1, further comprising:
if the communication does violate the communication policy rule, then preventing the document from being uploaded to a publishing server; and
preventing the communication from being delivered to the designated recipient.

4. The method of claim 1, further comprising:
employing a policy agent that resides at the communication server for determining if the communication violates the communication policy rule; and
employing an upload agent that resides at the communication server for automatically uploading the document to a publishing server if the communication does not violate the communication policy rule.

5. The method of claim 4, further comprising:
applying the policy agent to the communication upon initial receipt of the communication at the communication server; and
releasing the communication from the policy agent to the upload agent for automatic uploading of the document to the publishing server if the communication does not violate the communication policy rule.

6. The method of claim 1, wherein the document is attached to the communication.

7. The method of claim 6, further comprising:
if the communication does not violate the communication policy rule, removing the attached document from a body of the communication;
transferring the document to a document repository; and
storing the body of the communication separately at the communication server.

8. The method of claim 7, further comprising:
replacing the attached document in the body of the communication with a link to the stored document in the document repository prior to forwarding the communication to the designated recipient.

9. The method of claim 6, further comprising:
if the communication does violate the communication policy rule, then:
removing the attached document from the communication; and
enabling the communication server to deliver the communication to the designated recipient without the attached document.

10. The method of claim 6, further comprising:
if the communication does violate the communication policy rule, then:
removing the attached document from the communication;
enabling the communication server to modify the communication to indicate that the communication violates the communication policy rule; and
enabling the communication server to deliver the modified communication to the designated recipient.

11. The method of claim 1, further comprising:
if the communication does violate the communication policy rule, generating a message informing the sender that the communication was not delivered.

12. A communication server for enforcing communication policy rules for document sharing in a collaborative environment, comprising:
a memory storing instructions;
a processor coupled to the memory, the processor executing a communication application, wherein the communication application is configured to:
receive a communication associated with a document from a sender to a designated recipient;
employ a policy agent to determine if the communication violates the communication policy rule;
if the communication does not violate the communication policy rule, then:
release the communication from the policy agent to an upload agent for automatic uploading of the document to a publishing server;
deliver the communication to the designated recipient; and
enable the designated recipient to access the document through the publishing server.

13. The communication server of claim 12, wherein the communication application is further configured to:
if the communication does violate the communication policy rule, then:
prevent uploading of the document to the publishing server; and
one of: prevent delivery of the communication to the designated recipient and forward a message to at least one of the designated recipient and the sender indicating that the communication violates the communication policy rule.

14. The communication server of claim 12, wherein the communication includes at least one from a set of: an e-mail message, a text message, an online conference exchange, a whiteboard sharing exchange, a desktop sharing exchange, and application sharing exchange.

15. The communication server of claim 12, wherein the policy agent and the upload agent are implemented as independent modules for enforcing the communication policy rule.

16. The communication server of claim 12, wherein the communication application is further configured to:
apply the upload agent first upon receipt of the communication by the communication server to automatically upload the document to the publishing server;
apply the policy agent next to determine if the communication policy rule is violated; and
if the policy agent determines that the communication policy rule is violated, prevent the communication server from delivering the communication to the designated recipient.

17. The communication server of claim 16, wherein the communication application is further configured to:
if the policy agent determines that the communication policy rule is violated, enable the policy agent to flag the uploaded document at the publishing server; and
enable the publishing server to set permission and access settings to prevent unauthorized users from accessing the uploaded document at the publishing server.

18. The communication server of claim 12, wherein the document includes one of: a word processing document, a spreadsheet document, a presentation document, an audio file, a video file, an email message, a calendar item, and a graphic file.

19. A computer-readable memory device with instructions stored thereon for enforcing communication policy rules for document sharing between a communication server and a publishing server in a collaborative environment, the instructions comprising:
receiving a communication associated with a document from a sender to a designated recipient through a communication server in the collaborative environment;
determining a communication policy rule associated with the communication; and
employing a policy agent that resides at the communication server for determining if the communication violates the communication policy rule;
if the communication does not violate the communication policy rule, then:
employing an upload agent that resides at the communication server for automatically uploading the document to the publishing server; and
delivering the communication to the designated recipient;
if the communication does violate the communication policy rule, then:
preventing the document from being uploaded to a publishing server;
preventing the communication from being delivered to the designated recipient; and
generating a message informing at least one of the designated recipient and the sender that the communication was not delivered.

20. The computer-readable memory device of claim 19, wherein the communication policy rule includes one or more of: specifying that communication between predefined users and groups is prohibited, document sharing between predefined users and groups is prohibited, communication including confidential content is prohibited, communication including illegal content is prohibited, and communication including offensive content is prohibited.
